(19) United States
(12) Patent Application Publication
(10) Pub. No.: US 2019/0318663 A1
(43) Pub. Date: Oct. 17, 2019

(54) PORTABLE AND COLLAPSIBLE SAND TABLE

(71) Applicant: Carlos Ortiz, El Paso, TX (US)

(72) Inventor: Carlos Ortiz, El Paso, TX (US)

(21) Appl. No.: 15/954,625

(22) Filed: Apr. 17, 2018

(51) Int. Cl. G09B 25/06; G09B 19/00; A47B 37/00; A47B 13/08; A47B 3/12

(52) U.S. Cl. CPC G09B 25/06; G09B 19/00; A47B 37/00; A47B 2003/008; A47B 3/12; A47B 13/083; A47B 13/088

(57) ABSTRACT

A portable sand table, including a body including a top surface and a raised border disposed along a perimeter of the top surface, a plurality of hinges disposed at a bottom surface of the body to allow the body to fold in half, a plurality of removable legs to extend perpendicularly from the bottom surface of the body, and a plurality of leg storage portions disposed at the bottom surface of the body to store the plurality of removable legs therein when the removable legs are removed from the bottom surface of the body.

### BACKGROUND

### 1. Field

The present general inventive concept relates generally to table, and particularly, to a portable and collapsible sand table.

### 2. Description of the Related Art

In the Armed Forces of the United States of America, soldiers in training must be briefed on key details before heading out to execute their missions in order to be effective. Knowing this, an instructor may wish to have some type of physical aid to complement their teaching and/or briefings that can demonstrate location, direction, elevation and/or terrain features, so that their trainees may be best prepared.

Therefore, there is a need for a device to act as a means to recreate a physical image and/or scenario in any place or time, intended mainly for armed forces training and planning purposes.

### SUMMARY

The present general inventive concept provides a portable and collapsible sand table.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a portable sand table, including a body including a top surface and a raised border disposed along a perimeter of the top surface, a plurality of hinges disposed at a bottom surface of the body to allow the body to fold in half, a plurality of removable legs to extend perpendicularly from the bottom surface of the body, and a plurality of leg storage portions disposed at the bottom surface of the body to store the plurality of removable legs therein when the removable legs are removed from the bottom surface of the body.

The portable sand table may further include sand disposed on the top surface, such that the raised border prevents the sand from escaping from the top surface.

The plurality of leg storage portions may include rectangular prisms having a plurality of apertures corresponding with each other.

The portable sand table may further include a plurality of strap holders disposed on the bottom surface at side portions of the body, and a strap secured by the plurality of strap holders to secure the portable sand table in a folded position when the body is folded in half.

The portable sand table may further include a plurality of handles disposed at end portions of the body, such that the plurality of handles contact each other when the body is in a folded position.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an angled top perspective view of a portable sand table, according to an exemplary embodiment of the present general inventive concept;

FIG. 2 illustrates an angled upside-down perspective view of the portable sand table, according to an exemplary embodiment of the present general inventive concept;

FIG. 3 illustrates an angled upside-down perspective view of the portable sand table with a plurality of legs stowed, according to an exemplary embodiment of the present general inventive concept; and

FIG. 4 illustrates the portable sand table in a folded configuration, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

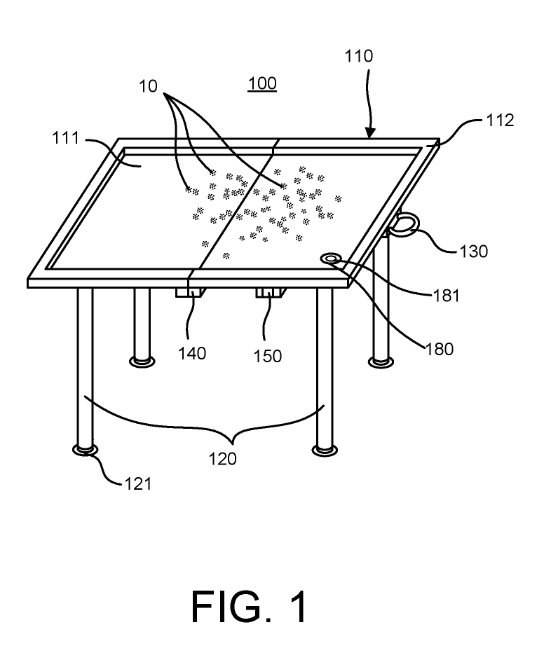

FIG. 1 illustrates an angled top perspective view of a portable sand table 100, according to an exemplary embodiment of the present general inventive concept.

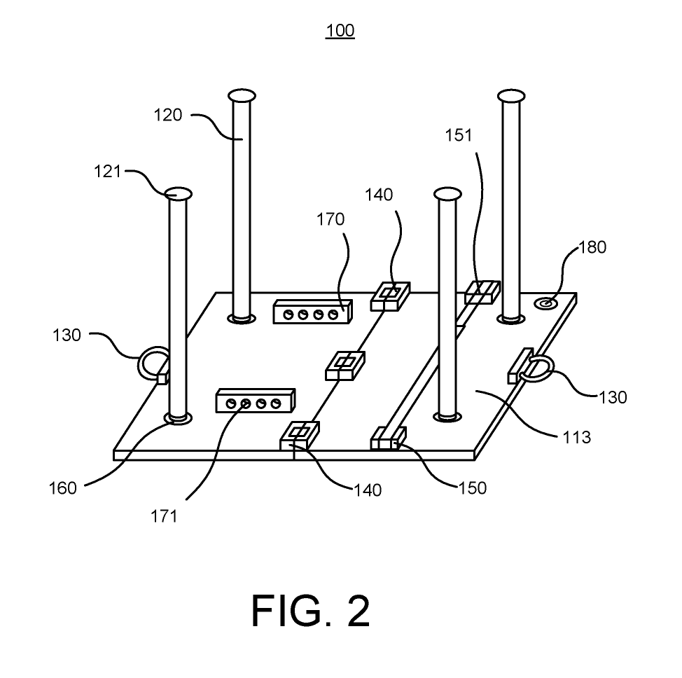

FIG. 2 illustrates an angled upside-down perspective view of the portable sand table 100, according to an exemplary embodiment of the present general inventive concept.

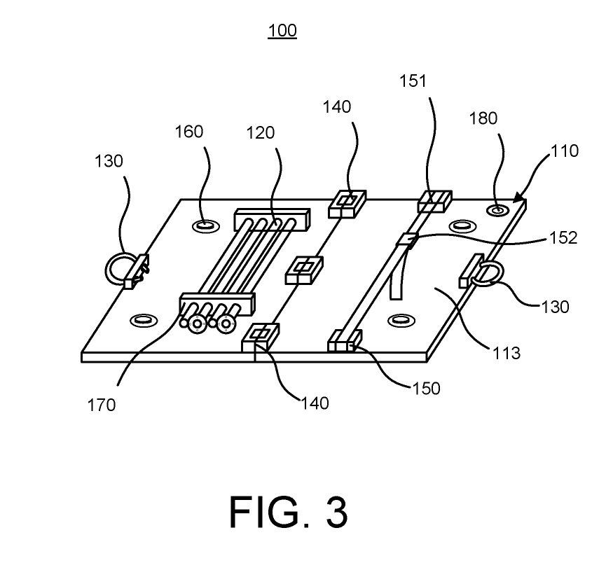

FIG. 3 illustrates an angled upside-down perspective view of the portable sand table 100 with a plurality of legs 120 stowed, according to an exemplary embodiment of the present general inventive concept.

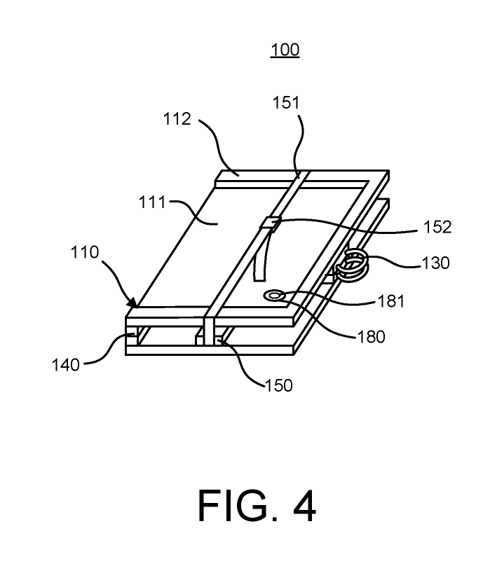

FIG. 4 illustrates the portable sand table 100 in a folded configuration, according to an exemplary embodiment of the present general inventive concept.

The portable sand table 100, and components thereof, may be constructed from wood, metal, plastic, rubber, or any other material known to one of ordinary skill in the art.

Referring to FIGS. 1 and 2, the portable sand table 100 may include a body 110, a plurality of legs 120, a plurality of handles 130, a plurality of hinges 140, a plurality of strap holders 150, a plurality of leg holes 160, and a plurality of leg storage portions 170.

The body 110 may include a top surface 111 and a raised border 112 disposed along a perimeter of the top surface 111. Sand 10, or any other materials, may be placed upon the top surface 111, such that the raised border 112 prevents the sand 10 from spilling out of the top surface 111.

The plurality of legs 120 may be provided as a set of four legs, and the plurality of legs 120 may be removably screwed (or inserted) into the plurality of leg holes 160, such that the plurality of legs 120 extend perpendicularly from a bottom surface 113 of the body 110. Each of the plurality of legs 120 may include a base 121 to prevent the portable sand table 100 from sliding.

The plurality of legs 120 may be disposed at corners of the body 110, but are not limited thereto.

The plurality of handles 130 may be disposed at end portions of the body 110, and may be used to lift and transport the portable sand table 100 when the portable sand table 100 is in a folded position, as illustrated in FIG. 4. As such, the plurality of handles 130 may contact each other when the body 110 is in a folded position.

The plurality of hinges 140 may be disposed on the bottom surface 113 of the body 110 along a center portion of the body 110, and may be constructed to allow the body 110 to be folded in half.

The plurality of strap holders 150 may be disposed at side portions of the body 110. The plurality of strap holders 150 may include a strap 151 attached thereto. The strap 151 may include a buckle 152 to allow the portable sand table 100 to be strapped down and secured to remain in the folded position.

The plurality of leg storage portions 170 may be disposed at the bottom surface 113 of the body 110, and may be used to store the plurality of legs 120 therein. The plurality of leg storage portions 170 may each have a rectangular prism shape with four apertures 171 to hold the plurality of legs 120.

More specifically, referring to FIG. 3, when the plurality of legs 120 are removed from the plurality of leg holders 160, the plurality of legs 120 may be stowed and stored within the apertures 171 of the plurality of leg storage portions 170. As such, the plurality of leg storage portions 170 may be disposed at the bottom surface 113 of the body 110, such that the apertures 171 of each of the plurality of leg storage portions 170 are correspondingly aligned.

Referring to FIGS. 1 through 4, the top surface 111 may include a drain hole 180 that goes through the body 110 all the way through the bottom surface 113. The drain hole 180 may be disposed at a corner of the body 110.

A cap 181 may be used to plug the drain hole 180, to prevent the sand 10 from exiting the top surface 111 of the body 110. The cap 181 may be removed when a user desires to drain the sand 10 from the top surface 111 of the body 110.

Accordingly, the portable sand table 100 may be foldable and/or collapsible, in order to allow a user to easily transport it.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A portable sand table, comprising:
a body comprising a top surface and a raised border disposed along a perimeter of the top surface;
a plurality of hinges disposed at a bottom surface of the body to allow the body to fold in half;
a plurality of removable legs to extend perpendicularly from the bottom surface of the body; and
a plurality of leg storage portions disposed at the bottom surface of the body to store the plurality of removable legs therein when the removable legs are removed from the bottom surface of the body.

2. The portable sand table of claim 1, further comprising:
sand disposed on the top surface, such that the raised border prevents the sand from escaping from the top surface.

3. The portable sand table of claim 1, wherein the plurality of leg storage portions comprise rectangular prisms having a plurality of apertures corresponding with each other.

4. The portable sand table of claim 1, further comprising:
a plurality of strap holders disposed on the bottom surface at side portions of the body; and
a strap secured by the plurality of strap holders to secure the portable sand table in a folded position when the body is folded in half.

5. The portable sand table of claim 1, further comprising:
a plurality of handles disposed at end portions of the body, such that the plurality of handles contact each other when the body is in a folded position.
